(19) United States
(12) Patent Application Publication
(10) Pub. No.: US 2011/0292429 A1
(43) Pub. Date: Dec. 1, 2011

(54) METHOD FOR PROCESSING DOCUMENTS ON AN IMAGE-PROCESSING APPARATUS

(75) Inventors: Anita C. MORSKATE, Tegelen (NL); Lambertus A.H. VAN VONDEREN, Venray (NL); Frederik DE JONG, Swalmen (NL)

(73) Assignee: OCE TECHNOLOGIES B.V., Venlo (NL)

(21) Appl. No.: 13/188,875

(22) Filed: Jul. 22, 2011

Related U.S. Application Data
(63) Continuation of application No. PCT/EP2010/050904, filed on Jan. 27, 2010.

(30) Foreign Application Priority Data
Feb. 6, 2009 (EP) 09152281.3

(51) Int. Cl. G06F 3/12

(52) U.S. Cl. 358/1.13; 358/1.18

(57) ABSTRACT

The invention relates to a method for processing documents on an image-forming apparatus, which is able to handle a plurality of settings, each setting settable to any of a number of setting values, the method comprising the steps of defining a first subset of the settings, defining a second subset of the settings, disjunctive from the first subset, for each setting of the first subset setting any of a number of setting values, which are selectable for the setting, for each setting of the second subset leaving the corresponding setting values unset, and for each document to be processed, creating a job for processing the digital document, associating the first and second subset and the setting values of the first subset with the job, interactively setting a setting value for each setting of the second subset, submitting the job with the setting values of the first and second subset to the image-forming apparatus, and processing the document by means of the image-forming apparatus according to the setting values of the first and second subset. The invention also relates to an image-forming apparatus and a computer program product for performing the steps of the claimed method.

The present invention relates to a method for processing documents on an image-processing apparatus, which is able to process documents according to a plurality of settings, each setting sellable to a value, said method comprising for each document: processing the document according to the values of the settings.

Such a method for processing digital documents has, for example, been disclosed by patent application EP 1557749. The method disclosed in this patent application is suitable for printing documents from a user workstation and comprises activating a printer driver for submitting a digital document file to a printer, specifying print process settings in the printer driver and commanding the driver to submit the document file and the settings to the printer, wherein values of settings are either individually or collectively specified. Such a collective specification is defined as a selection of a user-selectable prestored set of settings and is often called a template. For example, a printer driver window includes a plurality of buttons associated with such a prestored set of settings.

In the patent application US 2007/0097437 also a template is used. According to this patent application a user, when submitting a job to a printing device, may select a medium setting template out of a number of medium setting templates in combination with a tray selection out of a number of trays. A medium setting template contains a first subset of settings comprising mediums available for the printing device. A tray is selected from a second subset of settings comprising trays of the printing device. While submitting a job to the printing device, each time the user asks for the first subset of settings (a medium setting template), he also has to make a choice from the second subset of settings (a tray of the printing device). No tray fields are included in the medium setting template.

According to EP 1557749, mentioned above, each time a value of at least one of a predetermined set of settings is individually specified and confirmed by the user, a new template is automatically defined and made selectable in the printer driver. However this aspect will lead to a large number of templates in the case that the user often changes such a value. To overcome this problem, newly-defined templates may for example not be immediately permanent, but may be made so by a save action of the user.

However, for some settings the value may change per job. For example, a number of copies of a job, or, in case of scan jobs, an e-mail address to which a result of a scan job has to be sent, may vary for subsequent jobs. Every time a setting value changes, the job has to be defined with another template. The user has to select or create another template every time a setting value changes. This will take a substantially amount of time and is a repetitive action for the user.

The object of the present invention is to provide a method for processing documents on an image-processing apparatus in which the above-mentioned problem is mitigated.

This object is achieved by a method comprising, before processing the documents, the steps of defining a first subset of the settings, defining a second subset of the settings, disjunctive from the first subset, setting a value for each setting of the first subset, and the method further comprising for each document to be processed the step of creating by the user, a job with job data and the settings comprising the first and second subset, automatically requesting a value for each setting of the second subset, and entering a value for each setting of the second subset by the user.

The frequency of changing a value for a setting may vary from a situation in which a value of a setting is equal for a large number of jobs to a situation in which a value of a setting is changing per job. Therefore, before the creation of any job for processing the documents, the user is able to select two subsets of the plurality of settings. A first subset of the plurality of settings may be selected comprising settings which have values which are equal for large number of jobs and are suitable to be set at once. A second subset of the plurality of settings may be selected, disjunct from the first subset, comprising settings which values change more frequently. Defining the first subset, setting values for the first subset and defining the second subset may be done individually by the user or company-wise by an information services department.

For each document to be processed, a job is created for processing the document with job data and the here-above mentioned plurality of settings which comprise the first and second subset. The values of the first subset are set and the document is going to be processed according to the values of the first subset. Before processing the document, the user is requested for the values of the second subset via a user interface of the image-processing apparatus or via a user interface on a user work station, for example a user interface of a driver which is suitable for the image-processing apparatus. Entering the values of the second subset does not take very much time, since the number of settings of the second subset is generally not large. The job will not be processed until each setting of the second subset has been provided with a value entered by the user. As soon as the values of the second subset are provided by the user, the values of the second subset are set in the plurality of settings of the job and the document may be processed by the image-processing apparatus according to the values of the first and second subset. Since the user is actually obliged to enter the values of the second subset, it is not possible for the user to forget entering these values.

In an embodiment the method comprises an additional step of creating a template, as defined according to EP 1557749, comprising the first subset and second subset, wherein for each setting of the first subset a value has been set. The values of the first subset may be the same for a large number of jobs. Per an instance of values of the first subset at least one second subset may be defined. By applying this embodiment, the problem of the prior art, mentioned before, is mitigated by the creation of a template comprising a first and second subset as defined above. A number of jobs which are processed on the image-processing apparatus may use such a template. The first and second subset may be defined before the creation of the jobs to be processed, for example, during the creation of the template.

The values of the first subset, which are needed as settings of the jobs, are set during creation of the template before the creation of any job. After defining the first subset and the second subset and setting the values of the first subset, the definition of the template is complete. The user may decide to use this template for a specific job of the number of jobs in order to process a document on the image-processing apparatus. As soon as the user has exposed this decision by means of a printer driver for the image-processing apparatus, a local user interface of the image-processing apparatus or a web user interface for the image-processing apparatus, the user is automatically requested to enter the values of the second subset. Such a request is done before the document is processed. The user enters the values of the second subset by means of the printer driver, the local user interface or the web user interface. After entering the values of the second subset, the settings of the job, which comprise the first and second subset, are complete and the job is ready to be processed by the image-processing apparatus. The job is processed by the image-processing apparatus taking into account the settings of the job, comprising the values of the first and second subset.

In an embodiment a template is created which only contains the first subset of settings. The second subset of settings is not part of the template, but may be stored on a user workstation or in the memory of the image-processing apparatus. The second subset may be additionally asked for via a user interface. The user interface may be part of the image-processing apparatus or part of a program on a user workstation.

In an embodiment the method comprises a step of automatically proposing the creation of an additional template based on a number of previously created templates. Suppose a number of templates are created in such a way that the templates have a majority of settings and also the values of this majority of settings in common. The user may be proposed the creation of a new template which comprises a first subset of the common values of the common settings and a second subset of settings which are contained in the number of previously created templates and are not part of the just defined first subset. After creation of the new template, the number of previously created templates may be deleted by the user. This is advantageous because the number of templates is reduced and made more surveyable.

On the other hand, if it is recognised, for example by a controller of a processing apparatus, that a template is used frequently with the same values of the second subset except a few ones, the processing apparatus may propose the user, for example via a user interface of the processing apparatus, to create a new template in which the settings of the second subset, which values are the same for many jobs, are moved from the second subset towards the first subset. In this manner the user who uses the template has to make less effort in entering the values of the second subset since the number of settings in the second subset has been reduced.

In an embodiment the method is meant for processing documents on a printer, a copier, a scanner or a multifunctional apparatus which combines more than one of a printing, copying and scanning function. In case of a printer, print job settings may be set. Also a template containing print job settings may be used by the user. In case of a copier, copy job settings may be set via a local user interface coupled to the copier or via a workstation connected to the copier. Also a template containing copy job settings may be used, which may be stored on the copier.

In case of a scanner, scan job settings may be set via a local user interface coupled to the scanner or via a workstation connected to the scanner. Also a template containing scan job settings may be used.

In an embodiment the image-processing apparatus is a printer. The user may use a driver, being suitable for the printer and installed on a workstation of the user, in order to create templates with a first and second subset. The user may select via the driver a created template and try to send the job data and the settings to the printer. By doing so, the user may then be prompted by the driver to enter the values of the second subset. After completing the values of the second subset, the job settings are complete and the job may be automatically sent to the printer.

In another embodiment with a printer the user selects, e.g. via a driver, a previously created template with a first and second subset for a job and is actually able to send the job to the printer without entering the values of the second subset. When the job arrives at the printer, the job is put on hold until the user arrives at the printer. The user may release the job via a local user interface of the printer in order to let the printer print the documents associated with the job. When releasing the job, the user is requested for the values of the second subset which are part of the settings of the template of the job. In this manner the job is processed taking into account the values of the first and second subset of the template of the job.

In an embodiment the image-processing apparatus is a printer and the method is performed via a user interface on a user workstation. All steps of the method are performed via the user interface of a program installed on the user workstation. Such a program may be a driver, which shows the first subset and second subset of settings.

In an embodiment the user interface is a web user interface. A user workstation has a connection to a local area network, a wide area network or the internet. The web user interface contains fields to be filled with values for the first and second subset of settings.

In an embodiment the image-processing apparatus is a printer and the method is partially performed via a user interface of a user workstation and partially performed via a user interface of the image-processing apparatus. For example, the step of creating the first subset and the second subset and the step of setting a value for each setting of the first subset may be performed via the user interface of the workstation. After performing these steps the user may create a job for each document to be processed via the user interface of the workstation and submit the job to the printer. When the job has arrived at the printer and the job may be selected via the user interface of the printer, the remaining steps of automatically requesting a value for each setting of the second subset and entering a value for each setting of the second subset by the user may be performed via the user interface of the printer.

In an embodiment the steps of the method for defining a first and second subset and setting the values of the first subset are performed by means of a web user interface, which is enabling sending of the defined settings and values to the image-processing apparatus. Setting values for the second subset may be performed via a user interface of the image-processing apparatus.

The invention also relates to an image-processing apparatus comprising a user interface configured to perform steps of the invented method.

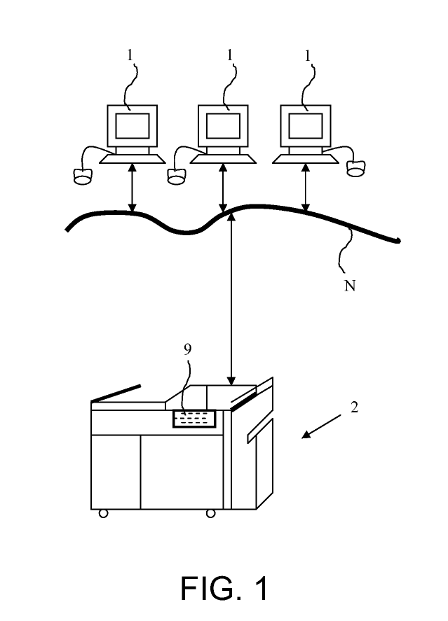

The invention is elucidated by reference to embodiments in conjunction with FIG. 1-8.

FIG. 1 shows a network system of workstations and an image-processing apparatus.

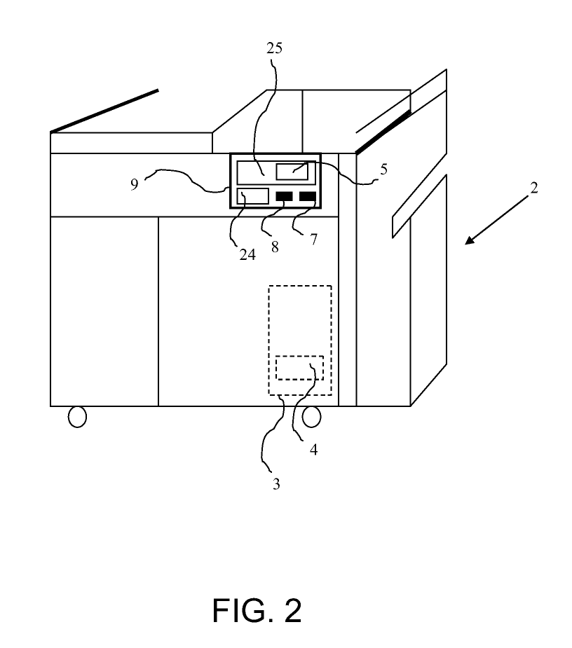

FIG. 2 shows a schematic functional view of an image-processing apparatus according to an embodiment of the invention.

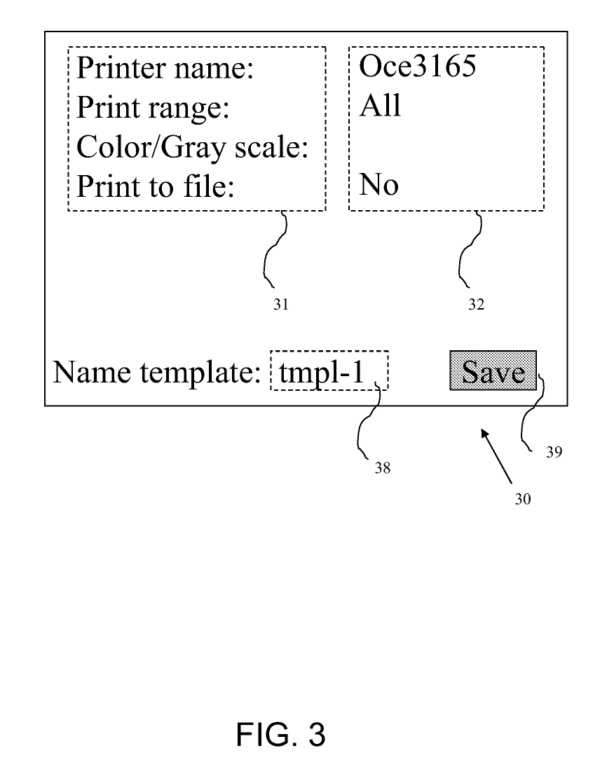

FIG. 3 shows a schematic view of a window of a user interface on a user workstation according to an embodiment of the invention.

FIGS. 4a-1 and 4a-2 show schematic views of windows of a user interface on a printer.

FIGS. 4b-1 and 4b-2 show schematic views of windows of a user interface on a scanner.

FIGS. 4c-1 and 4c-2 show schematic views of windows of a user interface on a copier.

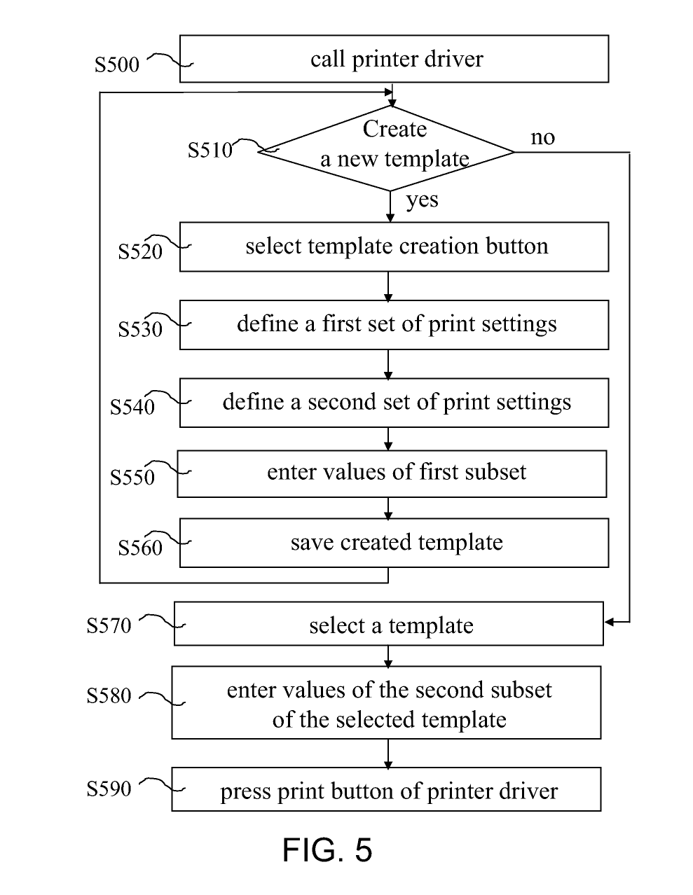

FIG. 5 shows a flow diagram presenting steps of the invented method performed by means of a printer driver, in case of a document to be printed.

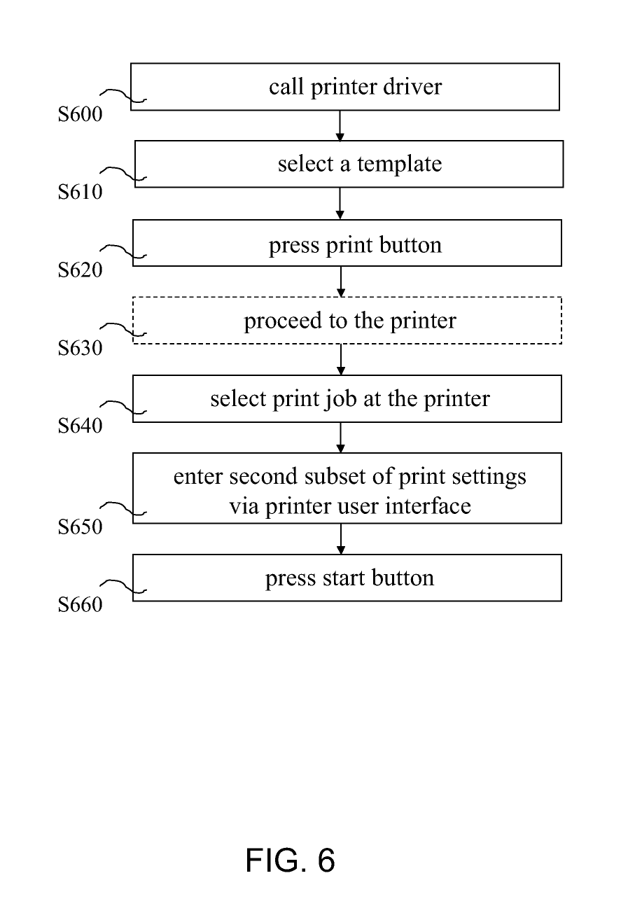

FIG. 6 shows a flow diagram presenting steps of the invented method performed by a user, partially by means of a printer driver, partially by means of a user interface of a printer, in case of a document to be printed.

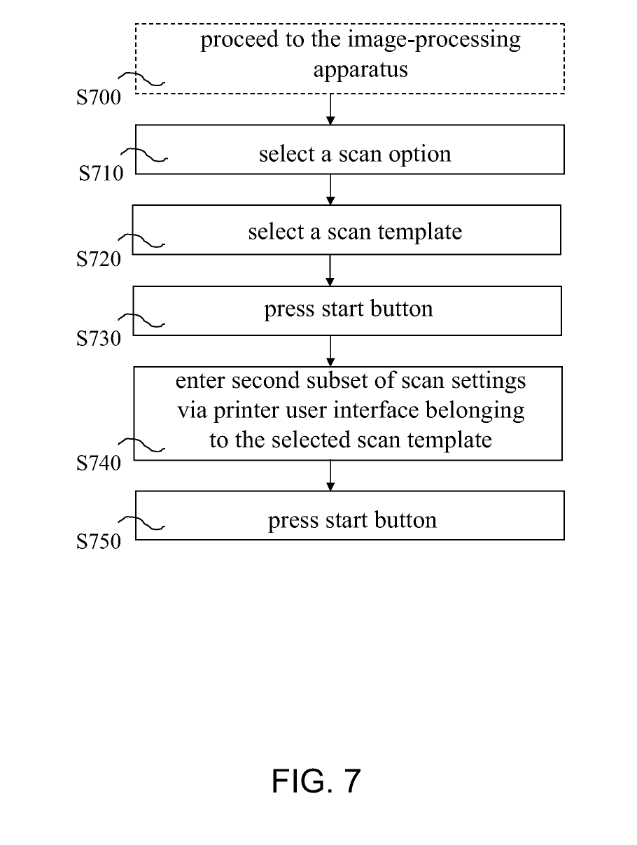

FIG. 7 shows a flow diagram presenting steps of the invented method performed by a user in case of a document to be scanned.

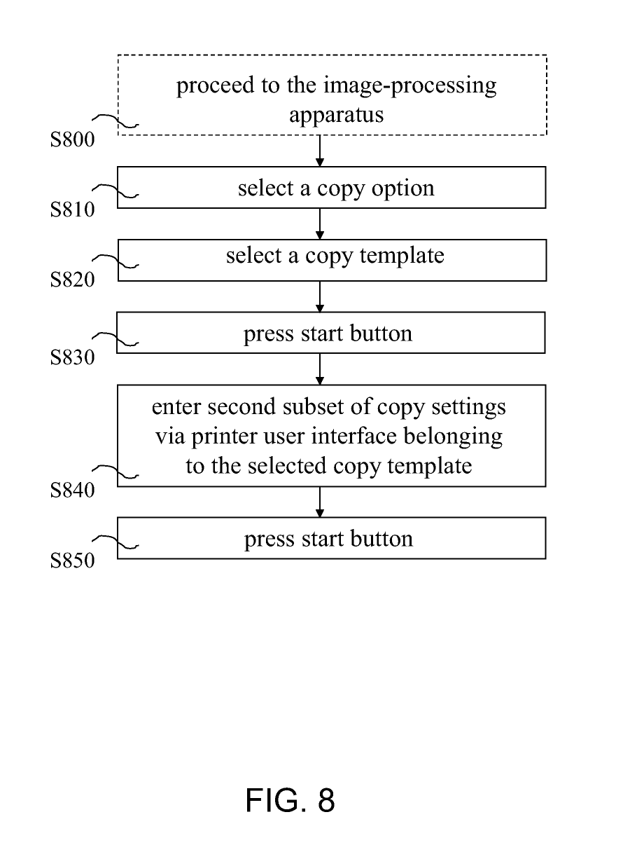

FIG. 8 shows a flow diagram presenting steps of the invented method performed by a user in case of a document to be copied.

FIG. 1 shows a system comprising workstations 1 connected to a local network N. The method according to an embodiment of the invention is particularly suited for use in this kind of environment, where an image-processing apparatus 2 is available for a user working with one of the workstations 1 and intending to print or to scan a set of documents and is also available for a user who just wants to copy a document. The image-processing apparatus 2 is connected to the network N and being suited for receiving print jobs from the workstations 1. The network N may be wireless. The image-processing apparatus 2 comprises a user interface 9, which will be elucidated further on.

In an embodiment each of the workstations 1 is a personal computer provided with a processor unit, a display unit, a keyboard and a mouse or any other input means in order to let a user, who is logged in on a workstation, print a document on the image-processing apparatus 2.

In an embodiment, shown in FIG. 2, the image-processing apparatus 2 comprises a user interface 9 comprising a start button 8 and a cancel button 7, and a controller 3 comprising a memory element 4 such as a hard disk, and is further connected to display means 25 and input means 24 such as a keyboard and a mouse for enabling a user to enter commands in order to execute printing of digital documents. The display means 25 may be realised by a touch screen. The cancel button 7 and the start button 8 may be part of the display means 25 if the display means 25 is a touch screen. The memory element 4 is suitable to contain a plurality of jobs which have been submitted to the image-processing apparatus 2 via the local network N (FIG. 1). Part of the plurality of jobs may be displayed on the display means 25. A user may select a job on the display means 25 he wants to process.

In an embodiment, in the case of a print job to be submitted by the user from his workstation, the workstation is provided with a so-called printer driver. A printer driver is an application controlled by the processor unit of the workstation and is able to perform the task of submitting digital documents to a printing apparatus as a print job. A flow chart of this embodiment is shown in FIG. 5. When a user wants to print one or more digital documents stored on memory means of the workstation or created by an application program running on the workstation, he or she calls up the printer driver (S500), for example by clicking an icon intended for this purpose (not shown). An interface displays a button for creating a template, such as described in EP 1557749 A1, for the one or more digital documents to be printed. If the user wants to create a new template (S510), the user selects the template creation button (S520). After clicking the template creation button, the printer driver may show a window 30, shown in FIG. 3, comprising print settings 31 and input fields 32. The values of the print settings 31 are specified by entering (S550) values for print settings in the input fields 32 by the user. The print settings which values are set at this moment, for example a printer name, a print range and a print-to-file option, define (S530) a first subset according to the invention. The print settings which values are not yet set at this moment, for example a color/gray scale option, define (S540) the second subset according to the invention. The user saves (S560) the defined template by giving the template a name 38 and pressing a save button 39. If the user wants to create another template, the steps S520-S560 described above may be repeated. In another embodiment the described steps S520-S560 may be executed via a call of a template driver, which is configured separate from the printer driver. According to this embodiment the first and second subset are implicit defined by entering values for print settings in the input fields 32. In another embodiment the steps of defining a first subset (S530) and defining a second subset (S540) may be separated from and preceding the step of entering values of the first subset (S550).

The user may use a created template when creating jobs to be sent to the printer 2.

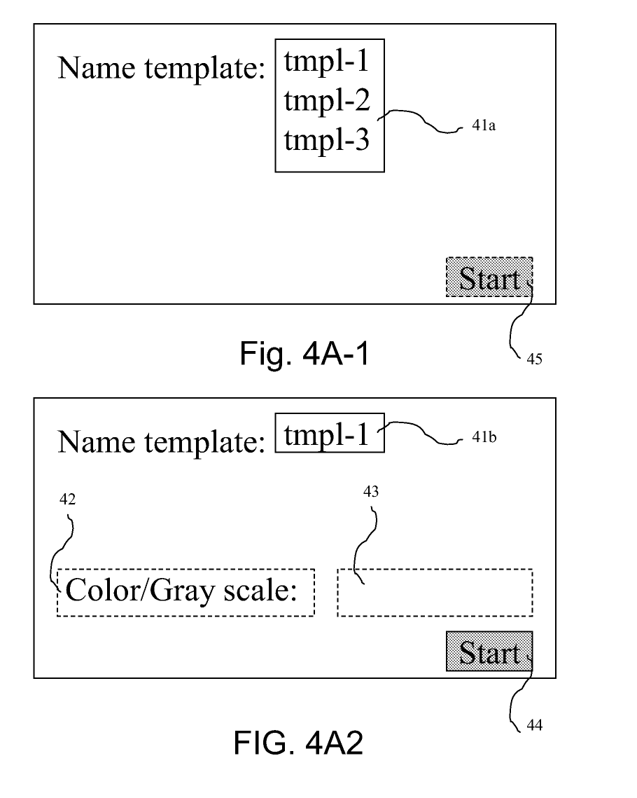

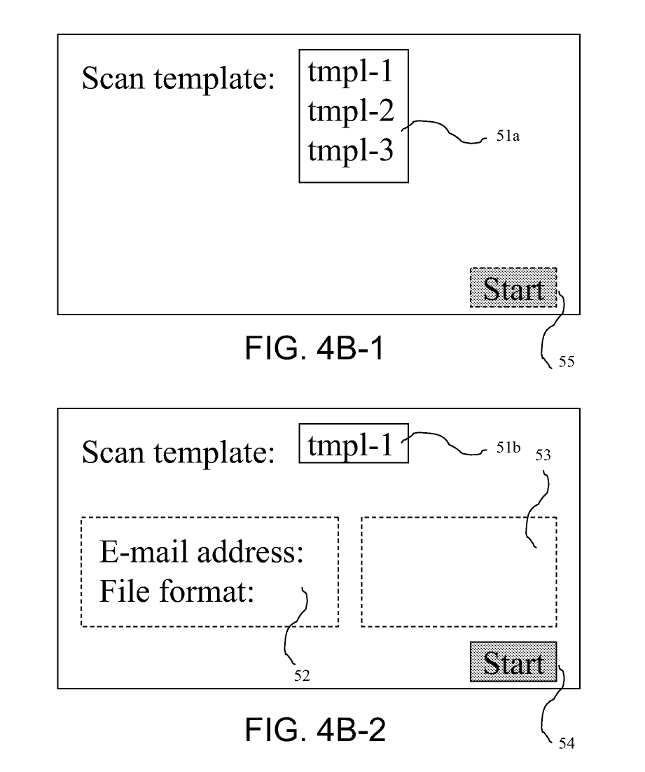

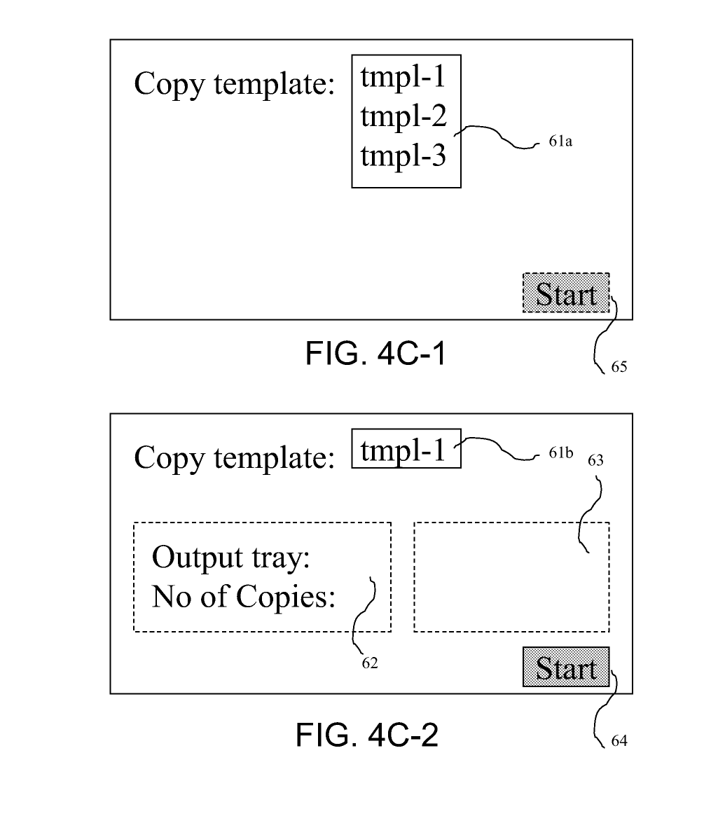

Therefore the printer driver may show a window according to FIG. 4a-1 on which a template may be selected (S570) by the user via a list of saved templates 41a. The window comprises a disabled start button 45. After selection of a template, e.g. tmpl-1, a window according to FIG. 4a-2 may be displayed to show input fields 43 for the second subset of print settings 42. The user enters (S580) values in the input fields 43. The job may be sent to the printer by pressing (S590) an enabled start button 44. After arrival of the job at the printer 2, the user may select the job to be printed and may press the start button 8 (FIG. 2). The job is printed without asking via the user interface of the printer for any additional print settings.

In another embodiment a print job is created at a workstation via the printer driver. A flow chart of this embodiment is shown in FIG. 6. The printer driver is called (S600) and the user selects (S610) a template from a list of available templates.

However, after selecting the template, the job is immediately sent to the printer 2 (FIG. 2) by pressing a print button (S620) and saved in the memory 4 (FIG. 2) of the printer 2. The user proceeds to the printer (S630) and at the printer 2 the print job in the memory 4 may be selected (S640) for printing, for example via the display means 25 (FIG. 2) of the printer 2. A window, similar to the window according to FIG. 4a-2, is shown by the display means 25 when the print job in the memory 4 has been selected to be processed. The window contains input fields for the not yet specified values of print settings belonging to the job. The user is obliged to specify (S650) the remaining settings by entering values into the input fields (If the job is wrong or has not to be printed the job may be cancelled by means of the cancel button 7 (FIG. 2)). The print settings which are to be specified by the user at the printer as described here-above, are called the second subset of print settings according to the invention. If the user has entered all input fields on the window, the start button 8 (FIG. 2) of the user interface 9 (FIG. 2) or a start button on the window may be pressed (S660) in order to let the printer 2 process the print job.

In an embodiment a print job is output of an application program residing on a user workstation. The application may be configured in such a way that the first set of print settings are set during preparing the print job by means of the application. When the user sends his print job to the image-processing apparatus 2 (FIG. 2), there are at least two possibilities. One possibility is that the user workstation shows a window in order to let the user enter the values of the second subset. In that case the print job is submitted to the image-processing apparatus 2 and is processed by the image-processing apparatus 2 without asking the user for any additional print settings at the image-processing apparatus 2. Another possibility is that the user is not asked for values of the second subset via the interface of the user workstation and the print job is sent to the image-processing apparatus 2. Display means 25 of the image-processing apparatus 2 shows a window 5 (FIG. 2) as soon as the job is going to be processed. The window 5 is configured in such a way that the user is forced to enter the values of the second set of print settings before printing happens.

A flow chart of a scan job is shown in FIG. 7. In the case of a scan job, the user proceeds (S700) to the image-processing apparatus 2 (FIG. 2) and selects a scan option (S710). The selection of the scan option may be omitted if the image-processing apparatus has solely scanning functionality. He may get a window according to FIG. 4b-1 on the display means 25 (FIG. 2) in order to select a scan template (S720) from a list of scan templates 51a, which have been created by the user himself, an operator or an information services department, or has been provided with the image-processing apparatus 2 at delivery. The window comprises a disabled start button 55. The selected scan template provides the user with a set of scan job settings which determine properties of a resulting file derived from the scanned document. According to the invention the set of scan job settings, which values have been set, is called the first subset according to the invention.

After selecting a scan template, for example a scan template named tmpl-1, the start button 55 is enabled. The start button 8 (FIG. 2) or the enabled start button 55 may be pressed (S730) in order to start the scan job. Directly after pressing one of the start buttons a window according to FIG. 4b-2 is shown on the display means 25. The window comprises a name 51b of the selected scan template, scan settings 52 belonging to the selected scan template and input fields 53 corresponding to the scan settings 52. The input fields 53 are to be filled (S740) with values by the user in order to specify the values of the second subset of scan job settings corresponding to the selected scan template. For example, the user is asked to specify an e-mail address, to which the scanned document has to be sent after scanning, or a desired file format of the scanned document. In particular the user specifies those values which are needed to process the scan job and are not yet set in the scan template. According to the invention those values are called the second subset according to the invention. After entering values in the input fields 53, the job may be processed, for example by pressing the start button 8 (S750) again or an enabled start button 54 of the window according to FIG. 4b-2.

In another embodiment, being similar to the embodiment described here-above, the window according to FIG. 4b-2 is immediately shown after the selection of the scan template (S720) in order to let the user enter the values of the second subset of scan settings 52 (S740). In this manner the start button 8 (FIG. 2) or the enabled start button 54 of the window according to FIG. 4b-2 needs only to be pressed once (S750).

A flowchart of a copy job is shown in FIG. 8. In case of a copy job, the user proceeds (S800) to the image-processing apparatus 2 (FIG. 2) and selects a copy option (S810). The selection of the copy option may be omitted if the image-processing apparatus 2 has solely copy functionality. He gets a window according to FIG. 4c-1, on the display means 25 (FIG. 2) in order to select a copy template (S820) from a list of copy templates 61a, which have been created by the user himself or an operator, or has been provided with the image-processing apparatus 2 at delivery. The window comprises a disabled start button 65. The selected copy template provides the user with a set of copy job settings which determine a result of copying the original document. According to the invention the set of copy job settings, which values have been set, is called the first subset according to the invention.

After selecting the copy template, the start button 64 is enabled and the start button 8 (FIG. 2) or the enabled start button 64 may be pressed (S830) in order to start the copy job. Directly after pressing the start button 8 or the enabled start button 64 a window according to FIG. 4c-2, is shown on the display means 25. The window comprises a name 61 b of the selected copy template, copy settings 62 belonging to the selected copy template and input fields 63 corresponding to the copy settings 62. The input fields 63 are to be filled (S840) with values by the user in order to specify the values of the second set of copy settings 62 belonging to the selected copy template. For example, the user specifies an output tray from which the paper has to be chosen onto which the document has to be copied, a number of copies, a simplex/duplex option etc. In particular the user specifies those values which are needed to process the copy job and are not yet set in the copy template. According to the invention those values are called the second subset according to the invention. After entering values in the input fields 63, the copy job may be processed, for example by pressing the start button 8 (S850) again or an enabled start button 64 of the window according to FIG. 4c-2.

In another embodiment, being similar to the embodiment described here-above, the window according to FIG. 4c-2 is immediately shown after the selection of the copy template (S820) in order to let the user enter the values of the second subset of copy settings 62 (S840). In this manner the start button 8 (FIG. 2) or the enabled start button 64 of the window according to FIG. 4c-2 needs only to be pressed once (S850).

The scan job described above may be processed on a multi-functional apparatus or a scanner. The copy job described above may be processed on a multi-functional apparatus or a copier.

Although the present invention has been described on the base of the embodiments above, the skilled person will recognize other embodiments within the scope of the claim formulations. Such embodiments are considered to be covered by the protection of the patent.

1. Method for processing documents on an image-processing apparatus, which is able to process documents according to a plurality of settings, each setting settable to a value, said method comprising for each document:
processing the document according to the values of the settings, wherein said method comprises, before processing the documents, the steps of
(a) defining a first subset of the settings,
(b) defining a second subset of the settings, disjunctive from the first subset,
(c) setting a value for each setting of the first subset, and, the method further comprising for each document to be processed the steps of
(d) creating, by a user, a job with job data and the settings defined in (a) and (b),
(e) automatically requesting a value for each setting of the second subset, and
(f) entering a value for each setting of the second subset by the user.

2. Method according to claim 1, wherein the method comprises an additional step of creating a template, being a user-selectable prestored set of settings, said template comprising the first subset and the second subset.

3. Method according to claim 2, wherein the method comprises a step of automatically proposing the creation of an additional template based on a number of previously created templates.

4. Method according to claim 3, wherein the image-processing apparatus is a printer, a copier or a scanner.

5. Method according to claim 4, wherein the image-processing apparatus comprises a local user interface by means of which the method is performed.

6. Method according to claim 4, wherein the image-processing apparatus is a printer and the method is performed via a user interface on a user workstation.

7. Method according to claim 6, wherein the user interface is a web user interface.

8. Method according to claim 6, wherein the user interface is a user interface of a printer driver.

9. Method according to claim 4, wherein the image-processing apparatus is a printer and the method is partially performed via a user interface of a user workstation and partially performed via a user interface of the image-processing apparatus.

10. Image-processing apparatus comprising a user interface configured to perform steps of the method according to claim 1.
